(19) United States
(12) Patent Application Publication
(10) Pub. No.: US 2025/0310537 A1
(43) Pub. Date: Oct. 2, 2025

(54) ADJUSTABLE RATE CONTROL STRENGTH FOR VIDEO ENCODING

(71) Applicant: ATI Technologies ULC, Markham (CA)

(72) Inventors: Dong Liu, Markham (CA); Haibo Liu, Markham (CA); Jin Li, Markham (CA)

(73) Assignee: ATI Technologies ULC, Markham (CA)

(21) Appl. No.: 18/620,617

(22) Filed: Mar. 28, 2024

(51) Int. Cl. H04N 19/146; H04N 19/124; H04N 19/176

(52) U.S. Cl. CPC H04N 19/146; H04N 19/124; H04N 19/176

(57) ABSTRACT

A technique is provided that includes encoding a block of a video based on a rate control strength parameter (“RC strength”) that controls a degree of influence of rate control over a quantization parameter of the block. The RC strength is useful to control the change in video quality that can occur as a result of rate control. More specifically, rate control adjusts the quantization parameter of blocks to account for a target bitrate. It is possible, for example, to increase the QP and thus decrease the quality for blocks due solely to bitrate. Such an adjustment could result in a reduction in encoding quality. The RC strength modifies the degree to which such rate control adjustments are made, which represents a tradeoff between meeting the requested encoding bitrate and improvements in image quality.

### BACKGROUND

Video encoding is the process of compressing video for transmission and storage. Advances in this area are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2A presents a detailed view of a video encoder, according to an example;

FIG. 2B represents a decoder for decoding compressed data generated by an encoder such as the encoder, according to an example;

FIG. 3 illustrates a frame being encoded, according to an example;

FIG. 4 illustrates a system for rate control, with consideration of a rate control strength, according to an example; and

FIG. 5 is a flow diagram of a method for encoding a video using an RC strength, according to an example.

### DETAILED DESCRIPTION

A technique is provided. The technique includes encoding a block of a video based on a rate control strength parameter (“RC strength”) that controls a degree of influence of rate control over a quantization parameter of the block. The RC strength is useful to control the change in video quality that can occur as a result of rate control. More specifically, rate control adjusts the quantization parameter of blocks to account for a target bitrate. It is possible, for example, to increase the QP and thus decrease the quality for blocks due solely to bitrate. Such an adjustment could result in a reduction in encoding quality. The RC strength modifies the degree to which such rate control adjustments are made, which represents a tradeoff between meeting the requested encoding bitrate and improvements in image quality.

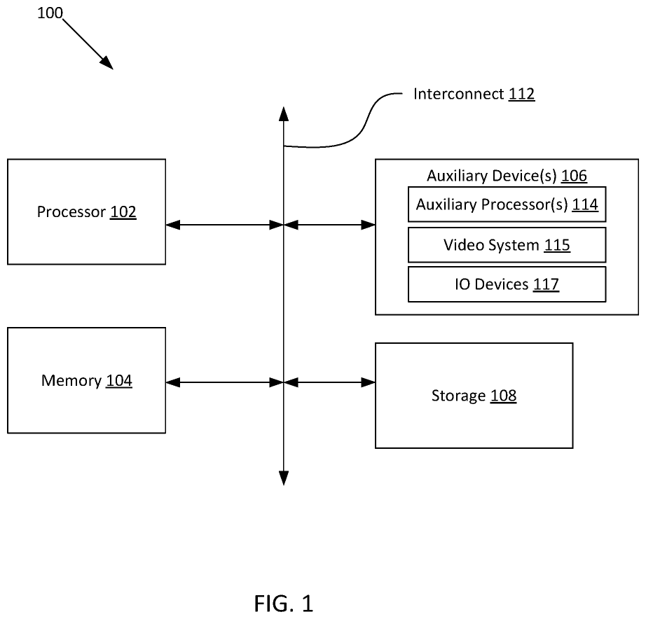

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

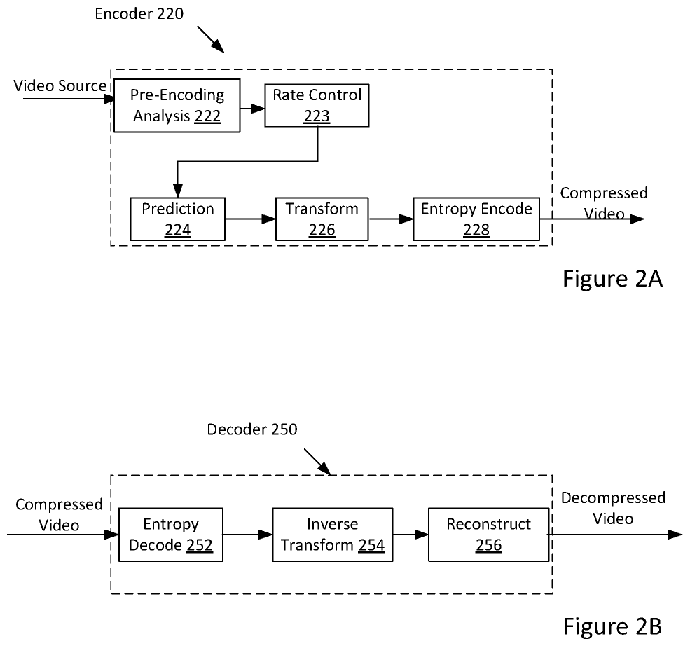

The one or more auxiliary devices 106 include a video system 115. The video system 115 includes one or both of a video encoder or a video decoder. In various examples, the video system 115 is implemented partially or fully in hardware (e.g., using circuitry such as a programmable processor and/or fixed-function circuitry), partially or fully in software executing on a processor, or as a combination there. Additional disclosure about the encoder and decoder are provided elsewhere herein, such as with reference to FIGS. 2A and 2B.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

FIG. 2A presents a detailed view of a video encoder 220, according to an example. The video encoder 220 accepts source video, encodes the source video to produce compressed video (or “encoded video”), and outputs the compressed video. Implementations of the encoder 220 may include blocks other than those shown. The encoder 220 includes a pre-encoding analysis block 222, a rate control block 223, a prediction block 224, a transform block 226, and an entropy encode block 228. In some alternatives, the encoder 220 implements one or more of a variety of known video encoding standards (such as MPEG2, H.264, or other standards), with the prediction block 224, transform block 226, and entropy encode block 228 performing respective portions of those standards. In other alternatives, the encoder 220 implements a video encoding technique that is not a part of any standard.

The rate control block 223 performs rate control for the encoder 220. Rate control involves setting the data consumption for blocks and frames being encoded based on a bit budget for the encoded video. The bit budget is a “target” amount of data to be consumed by a portion of video (e.g., a frame). In general, the rate control block 223 monitors the video during encoding for deviations from the bit budget and adjusts the quality (e.g., by adjusting the assigned quantization parameter to new blocks to be encoded) to better match the bit budget.

The prediction block 224 performs prediction techniques to reduce the amount of information needed for a particular frame. Various prediction techniques are possible. One example of a prediction technique is a motion prediction based inter-prediction technique, where a block in the current frame is compared with different groups of pixels in a different frame until a match is found. Various techniques for finding a matching block are possible. One example is a sum of absolute differences technique, where characteristic values (such as luminance) of each pixel of the block in the current block is subtracted from characteristic values of corresponding pixels of a candidate block, and the absolute values of each such difference are added. This subtraction is performed for a number of candidate blocks in a search window. The candidate block with a score deemed to be the “best,” such as by having the lowest sum of absolute differences, is deemed to be a match. After finding a matching block, the current block is subtracted from the matching block to obtain a residual. The residual is further encoded by the transform block 526 and the entropy encode block 228 and the block is stored as the encoded residual plus the motion vector in the compressed video.

The transform block 226 performs an encoding step which is typically lossy, and converts the pixel data of the block into a compressed format. An example transform that is typically used is a discrete cosine transform (DCT). The discrete cosine transform converts the block into a sum of weighted visual patterns, where the visual patterns are distinguished by the frequency of visual variations in two different dimensions. The weights afforded to the different patterns are referred to as coefficients. These coefficients are quantized and are stored together as the data for the block. Quantization is the process of assigning one of a finite set of values to a coefficient. The total number of values that are available to define the coefficients of any particular block is defined by the quantization parameter (QP). A higher QP means that the step size between values having unity increment is greater, which means that a smaller number of values are available to define coefficients. A lower QP means that the step size is smaller, meaning that a greater number of values are available to define coefficients. A lower QP requires more bits to store, because more bits are needed for the larger number of available coefficient values, and a lower QP requires fewer bits. Visually, a higher QP is associated with less detail and a lower QP is associated with more detail. Although the concept of QP is defined herein, the term “quality value” is sometimes used herein to generally refer to a value indicating the amount of data afforded for encoding a block, and thus the visual quality with which a block is represented in the encoded video. Numerically, quality value can be thought of as a ranking. Thus, a higher quality value means that a block is afforded a lower number of bits and is thus encoded with lower quality and a lower quality value means that a block is afforded a higher number of bits and is thus encoded with higher quality. It should be understood that although quality values are described herein as a “ranking” (with a lower number meaning higher quality and a higher number meaning lower quality), it is possible for other types of quality values to be used. For example, it is possible to use quality values where a higher number means a higher quality and a lower number means a lower quality. In some situations, the term quantization parameter is used herein. Any instance of that term can be replaced with the term “quality value.”

The entropy encode block 228 performs entropy coding on the coefficients of the blocks. Entropy coding is a lossless form of compression. Examples of entropy coding include context-adaptive variable-length coding and context-based adaptive binary arithmetic coding. The entropy coded transform coefficients describing the residuals, the motion vectors, and other information such as per-block QPs are output and stored or transmitted as the encoded video.

The pre-encoding analysis block 222 performs analysis on the source video for the purpose of adjusting parameters used during encoding. The pre-encoding analysis block 222 provides information to the rate control block 223 for performing rate control. In an example, the pre-encoding analysis block 222 performs statistical analysis on the content of the incoming raw video and provides information about such statistical analysis to the rate control block 223, which sets a quantization parameter for a block based on this information and additional analysis performed by the rate control block 223. Additional details about determining QPs for encoding blocks are provided below.

FIG. 2B represents a decoder 250 for decoding compressed data generated by an encoder such as the encoder 220, according to an example. The decoder 260 includes an entropy decoder 252, an inverse transform block 254, and a reconstruct block 256. The entropy decoder 252 converts the entropy encoded information in the compressed video, such as compressed quantized transform coefficients, into raw (non-entropy-coded) quantized transform coefficients. The inverse transform block 254 converts the quantized transform coefficients into the residuals. The reconstruct block 256 obtains the predicted block based on the motion vector and adds the residuals to the predicted block to reconstruct the block.

Note that the operations described for FIGS. 2A and 2B only represent a small subset of the operations that encoder and decoders may use.

In various examples, the encoder 220 and/or decoder 250 are implemented within the device 100. In an example, either or both of the encoder 220 and decoder 250 are any of software executing on a processor such as the processor 102 or the APD 116, hardware (e.g., circuitry) such as a processor of any type (e.g., a fixed function analog or digital processor, a programmable processor, a configurable logic array), or any other type of hardware, or a combination of software and hardware. In some examples, the device 100 (e.g., the video system 115) includes an encoder 220, a decoder 250, or both the encoder 220 and decoder 250.

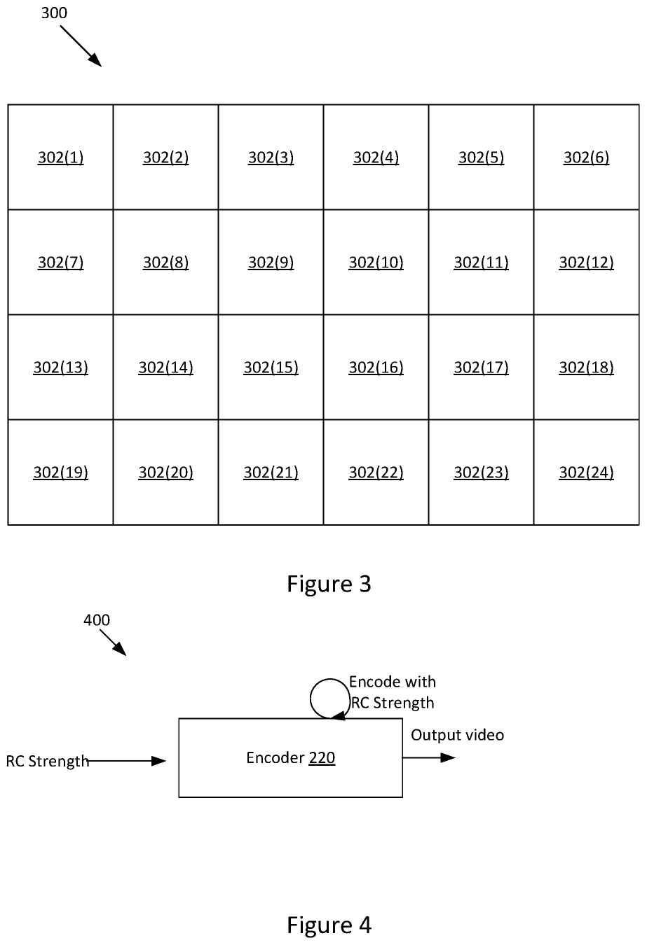

FIG. 3 illustrates a frame 300 being encoded, according to an example. The frame 300 includes a plurality of blocks 302. The blocks 302 correspond to a rectangular subdivision of the frame, with each block corresponding to a different such portion. In the unencoded data, each block encompasses a plurality of pixels of the unencoded data, where the plurality of pixels fall within the rectangular subdivision. In the encoded data, a block is a set of compressed data that, when uncompressed, results in the set of pixels of the corresponding block in the raw (uncompressed) data.

For the process of encoding, the encoder 220 determines the quantization parameters for each of the blocks 302. Ultimately, this determination affects the amount of data consumed by any particular block 302. In an example, the quantization parameter determines the number of possible values that the coefficients (e.g., discrete cosine transform coefficients) for the transform 226 operation can have. A larger quantization parameter means a greater numerical “spacing” between adjacent coefficient values in the set of possible values, which means that less data is needed to represent the coefficient values but that the fidelity of the information those values record is lower than if a lower quantization parameter is used.

The encoder 220 determines the quantization parameters for the blocks 302 based on a wide variety of factors. Some such factors include rate control factors, content complexity factors, buffer status factors (where the “buffers” are a variety of buffers involved in encoding and which may become full or empty based on the state of encoding), scene change factors, which indicate whether or not a scene change occurs (and thus where more information is needed due to the discontinuity between adjacent frames), feedback from previous frames, such as how much data such frames consume, perceptual considerations, and other factors. In various examples, where multiple such factors are considered, the encoder 220 determines a contribution for each such factor and combines all such contributions to determine the actual QP to be used for a given block 302. In some examples, the pre-encoding analysis block 222 performs pre-encoding analysis on the incoming frame (e.g., on the raw pixel data of the image to be encoded), and also, optionally, uses other factors such as system status and/or information about other frames, and provides information about such analysis to the encoder 220 (e.g., rate control 223) to assist the rate control 223 with determining a QP. Then, during encoding (e.g., processing through prediction 224, transform 226, and entropy encode 228), the rate control block 223 determines a QP in consideration of the information from the pre-encoding analysis block 222 and additional considerations such as rate control.

The encoder 220 is aware of an available bit budget and, based on how well the encoding is performing, determines the QPs for blocks to come in order to account for the bit budget. A bit budget is the amount of information that is available for the remaining portions of video (e.g., for the remaining blocks 302 of a frame 300 or the remaining frames 300 in a set of frames). In an example, the encoder 220 knows how much data is available for a given frame. While the encoder 220 is encoding blocks, the encoder 220 determines how much of the data for the frame has been taken up by the already encoded blocks. The difference between the amount of data already taken up by the encoded blocks and the amount of data available for a frame defines a bit budget delta. The encoder 220 sets the QPs for subsequent blocks based on this bit budget delta. In examples, if more data is available because already encoded blocks consume less data than expected, then the encoder 220 adjusts the QP for subsequent blocks downward, so that those subsequent blocks consume more data. The amount of data that is “expected” is determined in any technically feasible manner. In an example, this amount is based on the available bandwidth for a network connection over which the encoded video is to be transmitted. In another example, an encoding setting selects a particular bitrate for the video and this bitrate thus determines the amount of data that is available for a frame. It should be understood that the “adjustments” performed by the encoder 200, are performed to a QP that would occur without such adjustments (e.g., only in consideration of the information received from the pre-encoding analysis block 222).

In an example, the encoder determines a first QP for a first block 302. A bit budget describes how much data a frame is permitted to use for a frame. The encoder 220 keeps track of how much of this bit budget is used up for a given frame and compares the budget for a given block 302 to the amount of data actually consumed by that block. Continuing with this example, the encoder 220 encodes the first block using the first QP and determines that this first block used up too much data. Then the encoder 220 determines a QP for the second block at a value that is higher than the QP that would be determined by considering only the data from the pre-encoding analysis 222 block, without performing rate control analysis. It can be seen that the pre-encoding analysis 222 provides information for setting a QP based on non-real-time in-depth analysis of video, and additional operations in the encoder 220 set a QP based on this pre-encoding analysis information as well as based on operations that actually occur within the encoder 220.

Herein, the act of adjusting the QP in consideration of bit budgets is sometimes referred to as “rate control.”

FIG. 4 illustrates a system 400 for rate control, with consideration of a rate control strength, according to an example. In this example system, the encoder 220 accepts a rate control strength (“RC strength”) and applies the RC strength to encode the video. The rate control strength modifies the adjustment that the encoder 220 applies to the QP for rate control. In an example, if the strength indicates that the RC strength should be “weak” (e.g., the RC strength is at the low end of the range of possible values for RC strength), then the encoder 220 applies a smaller adjustment to the QP for rate control as compared with if the RC strength were strong (e.g., the RC strength is at the high end of the range of possible values for RC strength). In a more detailed example, the RC strength is 60%. The encoder 220 determines a rate control adjustment to apply to the QP for a block by multiplying 60% by an initially-determined rate control adjustment. In an example, if the initially-determined rate control adjustment is −2, the encoder 220 multiplies 60% by −2 to obtain −1.2 and applies that adjustment to the QP for the block (thus subtracting a value of 1.2 from the QP for the block).

In summary, the encoder 220 determines an initial QP for a block. In various examples, this determination is made without consideration of rate control factors such as how much data remains in a bit budget. In some examples, the encoder 220 determines the initial QP based on analysis of content of the video (e.g., using pre-encoding analysis), or based on any other factors. Once this initial determination is made, the encoder 220 determines a rate control adjustment. Based on a rate control strength, the encoder 200 adjusts the rate control adjustment and applies the rate control adjustment to the initial QP to obtain a resulting QP for the block. In some examples, the encoder 220 encodes the block using this resulting QP, and in other examples, the encoder 220 performs one or more further adjustments on the resulting QP to obtain a final QP and then encodes the block using the final QP.

In some examples, in applying the RC strength, the encoder 220 performs the following operations. The encoder 220 determines a block RC threshold. The block RC threshold is an adjustment of the bit budget for a block based on the RC strength. In some examples, the encoder 220 calculates the block RC threshold in the following manner:

blockRCThreshold=aveFrameBits/blockRCStrength

In the above formula, blockRCRCThreshold is the block RC threshold. The aveFrameBits is the amount of data afforded to the frame being encoded (e.g., an “average number of bits for the frame”). In some examples, the encoder 220 determines this value based on a frame rate for the video and a target bitrate (e.g., the amount of data that the video “should” consume, specified, e.g., by an encoder setting). In other words, the block RC threshold is a value that represents the amount of data afforded to a frame, as modified by the RC strength.

In some examples, the encoder 220 uses the block RC threshold to adjust the initial QP mentioned above. In some examples, the encoder 220 applies the adjustment in the following manner:

blockQP=(encodedBits−targetBits)/blockRCThreshold+initialQP

In the above formula, the resulting QP (for the block) is blockQP. encodedBits is the amount of bits already encoded for the frame (e.g., for all of the blocks of that frame previously encoded). targetBits is the amount of bits that “should” be consumed by the portion of the frame already encoded. blockRCThreshold is defined above. initialQP is the initially determined quantization parameter for the block. Thus, this formula indicates that the blockQP is equal to the difference between the number of bits actually encoded for the frame and the number of bits that “should” be consumed by that portion of the frame, modified by the blockRCThreshold to obtain an adjustment. Through addition, that adjustment is applied to the initial QP to obtain the resulting QP. The “amount of bits that should be consumed by the portion of the frame already encoded” means the amount of bits that such a portion should consume, according to the frame rate and target bitrate. In an example, if 50% of the blocks have been encoded, the target bitrate is a first amount of data per second, and the frame rate is 60 frames per second, then the amount of bits that should be consumed by the portion of the frame already encoded is equal to 50% × first amount of data per second/60. In other words, in this example, the amount of bits that should be consumed by the portion of the frame already encoded is equal to the number of bits afforded to a particular frame, given the bitrate and frame rate, reduced proportionally by the proportion of the frame already encoded. In summary, the above formulas indicate that the block QP equals the initial QP for that block, modified by an adjustment amount. The adjustment amount is equal the difference between the expected amount of data that has been used for the frame (e.g., according to the bitrate) and the actual amount of data that has been used for the frame, modified (e.g., divided by) the block RC threshold. The block RC threshold, itself, is based on the RC strength. Thus, the RC strength indicates how “strongly” to perform rate control for the QP of a block, where the rate control adjusts the QP of a block based on the actual amount of data used for a portion of the frame and the expected amount of data used for that portion of the frame.

It should be understood that the above formulas are examples of formulas that the encoder 220 could use for encoding video. However, the present disclosure contemplates other ways in which the encoder 220 uses an RC strength to modify the QP adjustment for blocks. In general, the encoder 220 determines an adjustment to apply to the QP for a block, where the adjustment reduces or increases the QP of the block so that the block consumes more or less data, as needed, to account for differences in “expected” data consumption and “actual” data consumption for the previously encoded blocks. The encoder 220 modifies this adjustment based on the RC strength, so that the applied adjustment is based on both the consideration of the above difference as well as the strength.

The RC strength is useful to control the change in video quality that can occur as a result of rate control. More specifically, rate control adjusts the quantization parameter of blocks to account for a target bitrate. It is possible, for example, to increase the QP and thus decrease the quality for blocks due solely to bitrate. Such an adjustment could result in a reduction in encoding quality. The RC strength modifies the degree to which such rate control adjustments are made, which represents a tradeoff between meeting the requested encoding bitrate and improvements in image quality. In other words, having a high RC strength means that the encoded video closely matches the requested bitrate while having a low RC strength means that the encoded video reduces variation in image quality (as compared with a high RC) while not necessarily matching the requested bitrate.

The RC strength is a parameter that is provided by any technically feasible entity. In some examples, a software application executing on the same device in which the encoder resides (e.g., in device 100) provides the RC strength parameter to the encoder. In various examples, the software application receives the parameter from a user (e.g., via a user interface or command line), has the RC strength hard coded in application code, or has an algorithm that determines the value of an adjustable RC strength. The application provides this RC strength to the encoder 220, which sets the QPs for the blocks being encoded accordingly. In other examples, a driver sets the RC strength based on user input or based on a hard-coded or algorithmically determined manner. In yet other examples, hardware (e.g., circuitry such as the encoder 220 itself) sets the RC strength in any technically feasible manner. The driver or hardware provides this RC strength to the encoder 220 which operates accordingly.

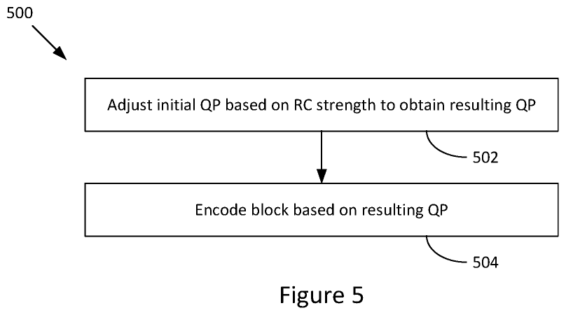

FIG. 5 is a flow diagram of a method 500 for encoding a video using an RC strength, according to an example. Although described with respect to the system of FIGS. 1-4, those of skill in the art will understand that any system configured to perform the steps of the method 500 in any technically feasible order falls within the scope of the present disclosure.

At step 502, the encoder 220 adjusts an initial QP based on an RC strength to obtain a resulting QP. This adjustment is a rate control adjustment, which modifies the QP for a block taking into account the difference between an “expected” amount of data consumed by the video and an actual amount of data consumed by the video, as described elsewhere herein. In addition, the adjustment takes into account the RC strength, which modifies the RC adjustment to be weaker or stronger. A weaker RC adjustment is useful where it is desirable to have a lower modification to the video quality (e.g., where it is desirable to retain video quality at the cost of additional data consumed by the encoded video). A strong RC adjustment is useful where it is desirable to maintain the video bitrate at the actually set target bitrate. As described elsewhere, the RC strength is provided in any technically feasible manner. In various examples, an application provides the RC strength, a device driver provides the RC strength, or hardware unit (such as the encoder 220 itself) provides the RC strength. In some examples, the application, device driver, or hardware unit obtains the RC strength from a human user (e.g., via a user interface), through algorithmic means (e.g., by executing software to determine an RC strength), or the RC strength is a hard coded parameter.

In various examples, determining the adjustment to the initial QP based on the RC strength is performed as follows. The encoder 220 determines bitrate delta which is based on the difference between the actual amount of data consumed for the blocks already encoded for a frame and the amount of data that is afforded to such blocks. The encoder 220 determines the adjustment based on this bitrate delta and the RC strength. A positive bitrate delta (meaning that the amount of data consumed by the blocks already encoded is less than the amount of data afforded to the blocks already encoded) results in a negative QP adjustment (thus the block currently being considered should consume more data) while a negative bitrate delta (the amount of data consumed by already encoded blocks is greater than the amount of data afforded by the already encoded blocks) results in a positive QP adjustment (the block currently being considered should consume less data). The degree of the bitrate delta results in a degree of QP adjustment. The RC strength, combined with the degree and sign (positive or negative) of the QP adjustment determined based on the bitrate delta, generates a QP adjustment that is applied to the initial QP value to obtain a resulting QP value as described elsewhere herein. The RC strength adjusts the magnitude of the QP adjustment determined based on the bitrate delta, with a higher RC strength resulting in a higher magnitude and a lower RC strength resulting in a lower magnitude. Thus, the RC strength changes the degree to which the bitrate delta adjusts the QP for a block.

At step 504, the encoder 220 encodes a block using the resulting QP. As described elsewhere herein, the QP determines the manner in which the coefficients for the transform operation 226 are set, with a higher QP resulting in a lower amount of data consumed and a lower QP resulting in a higher amount of data consumed. The encoder 220 processes the block through the stages described in FIGS. 2A, performing prediction 224, transformation 226, and entropy encoding 228 as described elsewhere herein.

In some examples, the encoder 220 performs the above operations for all blocks of a frame. In such an example, the encoder 220 encodes a first block, keeping a running comparison between the amount of data consumed by that first block and the amount of data afforded to that first block, and setting a QP adjustment for subsequent blocks based on the running comparison and the RC strength. The encoder 220 then encodes subsequent blocks, maintaining the same type of running comparison and making similar types of adjustments for such subsequent blocks until all blocks of the frame is completely encoded.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, interconnect 112, encoder 220, including pre-encoding analysis 222, rate control 223, prediction 224, transform 226, and entropy encode 228, and decoder 250, include entropy decode 252, inverse transform 254, and reconstruct 256, are implemented fully in hardware, fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
determining a rate control strength parameter that controls a degree of influence of rate control over a quantization parameter of a block of a video; and
encoding the block based on the rate control strength parameter.

2. The method of claim 1, wherein the rate control strength parameter is received from an application or a device driver.

3. The method of claim 2, further comprising accepting the rate control strength parameter via a user interface of the application or device driver.

4. The method of claim 1, wherein controlling the degree of influence of rate control over the quantization parameter of the block comprises modifying an initial quantization parameter of the block to obtain a resulting quantization parameter for the block, the modifying being based on the rate control and on the rate control strength parameter.

5. The method of claim 4, wherein the rate control comprises determining an initial quantization parameter adjustment based on a bit budget delta.

6. The method of claim 5, wherein the modifying the initial quantization parameter comprises reducing the initial quantization parameter adjustment based on the rate control strength parameter to obtain a reduced initial quantization parameter adjustment.

7. The method of claim 6, wherein the modifying the initial quantization parameter includes applying the reduced initial quantization parameter adjustment to the initial quantization parameter.

8. The method of claim 1, wherein the rate control comprises adjusting a quantization parameter for the block of the video based on a difference between an estimated amount of data consumed by previous blocks of a frame of the block and an amount of data actually consumed by the previous blocks.

9. The method of claim 1, further comprising repeating the encoding for each block of a frame.

10. A system comprising:
a memory configured to store information for a block of video; and
an encoding circuit configured to:
determine a rate control strength parameter that controls a degree of influence of rate control over a quantization parameter of the block; and
encode the block based on the rate control strength parameter.

11. The system of claim 10, wherein the rate control strength parameter is received from an application or a device driver.

12. The system of claim 11, wherein the rate control strength parameter is accepted via a user interface of the application or device driver.

13. The system of claim 10, wherein controlling the degree of influence of rate control over the quantization parameter of the block comprises modifying an initial quantization parameter of the block to obtain a resulting quantization parameter for the block, the modifying being based on the rate control and on the rate control strength parameter.

14. The system of claim 13, wherein the rate control comprises determining an initial quantization parameter adjustment based on a bit budget delta.

15. The system of claim 14, wherein the modifying the initial quantization parameter comprises reducing the initial quantization parameter adjustment based on the rate control strength parameter to obtain a reduced initial quantization parameter adjustment.

16. The system of claim 15, wherein the modifying the initial quantization parameter includes applying the reduced initial quantization parameter adjustment to the initial quantization parameter.

17. The system of claim 10, wherein the rate control comprises adjusting a quantization parameter for the block of the video based on a difference between an estimated amount of data consumed by previous blocks of a frame of the block and an amount of data actually consumed by the previous blocks.

18. The system of claim 10, wherein the encoding circuit is further configured to repeat the encoding for each block of a frame.

19. A non-transitory computer-readable medium storing instructions that, when executed by a processor, causes the processor to perform operations comprising:
determining a rate control strength parameter that controls a degree of influence of rate control over a quantization parameter of a block of a video; and
encoding the block based on the rate control strength parameter.

20. The non-transitory computer-readable medium of claim 19, wherein the rate control strength parameter is received from an application or a device driver.
